(19) United States
(12) Patent Application Publication
(10) Pub. No.: US 2021/0033135 A1
(43) Pub. Date: Feb. 4, 2021

(54) THREAD-FORMING SCREW AND PRODUCTION THEREOF

(71) Applicant: EJOT GmbH & Co. KG, Bad Berleburg (DE)

(72) Inventors: Michael ACHENBACH, Breidenbach (DE); Eberhard CHRIST, Tambach-Dietharz (DE)

(21) Appl. No.: 16/969,617

(22) PCT Filed: Feb. 14, 2019
(86) PCT No.: PCT/EP2019/053731

§ 371 Date: Aug. 13, 2020

(30) Foreign Application Priority Data
Feb. 14, 2018 (DE) 10 2018 103 325.7

(51) Int. Cl. F16B 25/00

(52) U.S. Cl. CPC F16B 25/0021; F16B 25/0094; F16B 25/0026; F16B 25/0042

(57) ABSTRACT

The invention relates to a thread-forming screw (10) comprising a base body (12, 20) which comprises a drive and a screw shank, the screw shank carrying a thread (13) having a channeling region (14) and a carrying region, the base body (12, 20) consisting of a base material. The invention is characterized in that the thread (13) is formed from a coating material (18) different from the base material, at least in the channeling region (14), which is applied to the base material by deposition welding.

The invention relates to a thread-forming screw as specified in the preamble of claim 1, and to a method for its production as specified in claim 10.

DE 10 2004 053 803 B4 discloses a thread-forming screw which has individual cutting means inserted along its thread-cutting portion, which cutting means are formed from a weld deposit.

It is generally known to produce thread-cutting screws in a two-steel design so as to make the load-bearing region and/or the screw head highly corrosion-resistant and at the same time obtain great hardness of the thread-cutting turns of the screw thread.

A screw of this type is disclosed in DE 20 2006 000 606 U1, for example.

The disadvantage of producing a screw in this way is that it requires the connection of two bolt parts each made of solid material. The connection of the two bolt parts results in a center offset that requires adjusting in a separate rolling operation.

It is the object of the invention to create a thread-forming screw that has a low susceptibility to corrosion and that allows the cutting of threads in components of higher strength, and to provide a method for the production of such a screw.

This object is accomplished by the characterizing features of claim 1 for the thread-forming screw, and by the features of claim 10 for the method for its production.

The subclaims relate to advantageous further developments of the invention.

In a known manner, a thread-forming screw comprises a base body having a drive and a screw shaft having a thread provided thereon. The thread has a thread-forming region and a load-bearing region, with the thread-forming region serving to form a thread in the material of the component in which the thread of the load-bearing region will then engage in the further course.

The base body, which comprises the screw shaft, is made of a base material that preferably has non-corrosive properties, i.e. in particular a rustproof and acid-resistant steel, hereinafter referred to as stainless steel. The terms material and substance are used interchangeably herein.

According to the invention, the thread in the thread-forming region is formed from a coating material that is different from the base material. In particular, this coating material is harder than the base material.

In the screw according to the invention, in particular deposition welding or thermal spray processes are used to deposit the coating material on the base body made of base material. This makes it possible to provide a screw whose thread turns are harder at least in the thread-forming region.

In deposition welding, volume is built by introducing only a welding consumable into the weld joint.

The base body may also be made of a light metal alloy, e.g. an aluminum alloy, and the coating material may be a different metal alloy or an alloy mixture.

The base material can preferably be an austenitic stainless steel, for example grade 1.4301 or 1.4401. The coating material is preferably a martensitic hardenable steel.

The coating material can also be a material mixture, for example comprising stainless steel, hard substances such as carbides or ceramics and other components having specific properties.

Using material mixtures is a flexible way to meet various application-specific requirements regarding the screw properties.

Preferably, the coating substances can be mixed during the welding process. As a result, the composition of the coating substance may also vary along the length of the thread.

A load-bearing region of the thread can also be made in this way using deposition welding, in which case the load-bearing region will have a different composition than the thread-forming region.

The layer thickness of the coating material is preferably at least 5% of the diameter of the screw shaft.

The invention furthermore relates to a method for the production of a screw of the aforementioned type, which has a drive and a screw shaft with a thread. The thread has a load-bearing region and a thread-forming region. The screw shaft is made from a base material.

The base body is first press-molded from the base material and then a coating material is deposition-welded onto the base material in the area of the thread-forming region of its thread. At least the edge of the thread in the thread-forming region is constituted by the coating material.

The base body may be cylindrical or non-circular in shape, in particular of equal thickness, elliptical or profiled.

In a first embodiment of the invention, it is possible to apply the thread directly onto the base material. This is in particular done by welding a bead onto and around the shaft in a helical shape, as is common for screws.

A self-tapping thread is thus produced directly by the welding of the thread. This makes it possible to produce threads that in particular have an obtuse flank angle or rounded thread flanks.

This can be implemented particularly well for coarse threads, such as those required for concrete screws. Concrete screws are defined as follows.

The thread applied to the screw shaft exclusively by deposition welding has a rough surface structure, resulting in the thread flank having abrasive properties for producing the counter thread.

The thread can preferably be produced by press molding the screw blank in such a way that it has a smaller radial extent in the region to be coated than in the region not to be coated.

The coating material is deposition-welded onto the base material, thus resulting in the base body of base material being coated with deposition-welded coating material. In particular, the coating is applied such that the screw shaft will have the same outer diameter throughout. The screw blank coated with the coating material then undergoes a rolling operation to provide it with its self-tapping thread.

In this way, self-tapping threads having a defined flank angle can be produced by subsequently shaping the deposition-welded material into such a form.

In this way, a thread-forming screw can be provided that has a high toughness also in the region of its self-tapping thread, and besides has good anti-corrosion properties in the load-bearing region of its thread and its head, and yet has hard thread flanks that allow it to be screwed into components of great hardness in a self-tapping manner.

According to another preferred embodiment, the coating material can be applied in dots, weld beads or over the entire surface, in particular over the entire surface of the base body formed from the base material.

The weld beads can be applied in a helical, circular or linear shape, in particular parallel to the screw axis.

In particular in the case of weld beads applied parallel to the screw axis, the screw shaft, especially the thread-forming region, can preferably be twisted for producing a thread structure.

The coating material can be applied in such a way that the coating material is deposition-welded onto the thread-forming region only. The result is a two-steel screw having a thread-forming thread of tempered steel in its thread-forming region and a thread of stainless steel in its load-bearing region.

This yields improved retaining and anti-corrosion properties with very good thread-forming characteristics.

This allows a screw to be provided having a rolled thread in both its deposition-welded thread-forming region and its load-bearing region. Alternatively, a screw can also be produced having a rolled thread in its load-bearing region and a thread in its thread-forming region that is constituted exclusively by the deposition-welded material which has not been treated mechanically.

The coating material can take the form of wire, powder, or of a molding.

Additional advantages, features and possible applications of the present invention may be gathered from the description that follows in which reference is made to the embodiments illustrated in the drawings.

In the drawings,

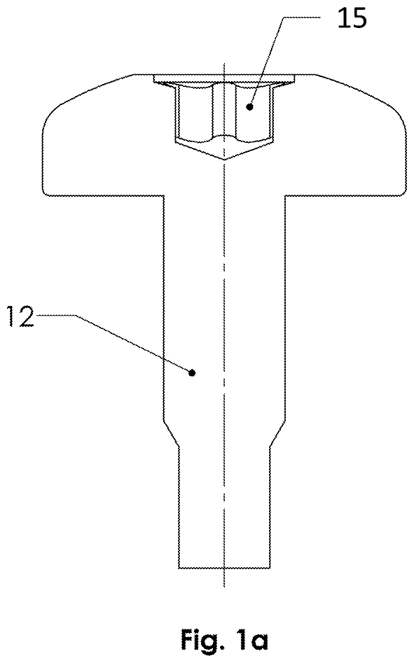

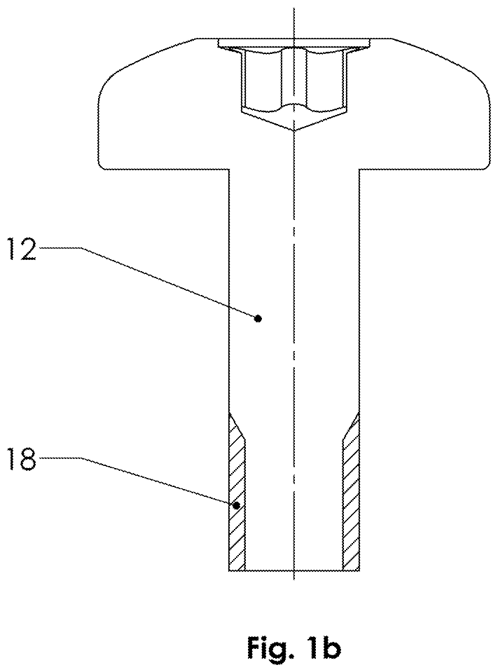

FIG. 1a is a lateral view of a screw blank;

FIG. 1b is a sectional view of a screw blank having coating material in its thread-forming region;

FIG. 1c is a sectional view of a thread-forming screw according to the invention;

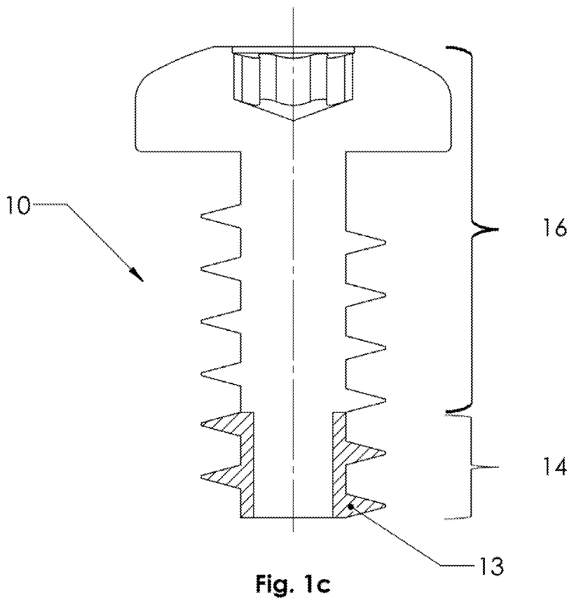

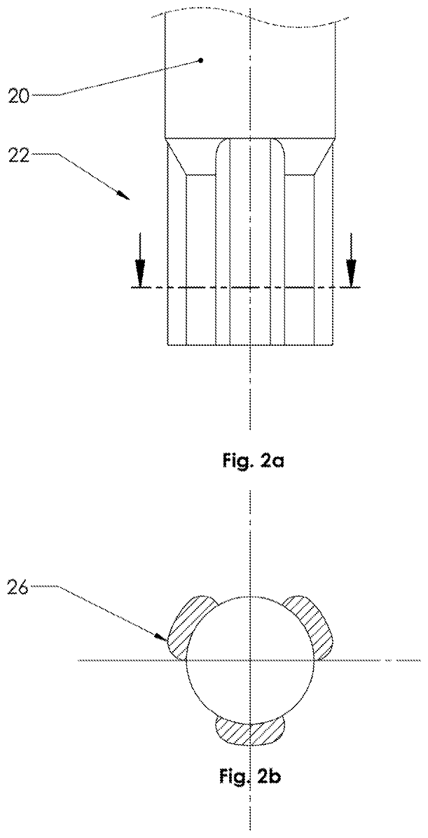

FIG. 2a is a partial lateral view of a screw blank coated according to the invention;

FIG. 2b is a cross-sectional view of a screw blank coated according to the invention;

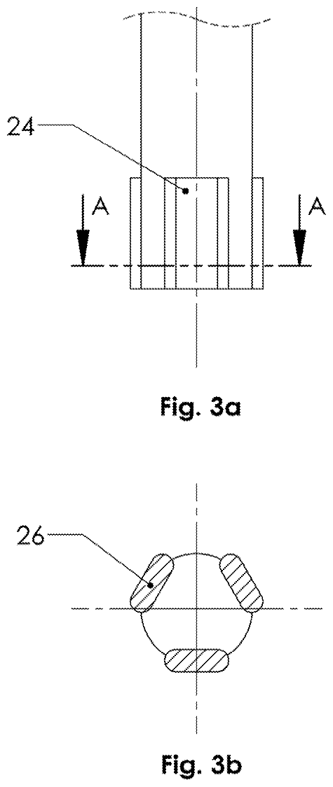

FIG. 3a is a partial sectional view of a screw blank according to the invention; and

FIG. 3b is a cross-sectional view of a coated screw blank as seen in FIG. 3a;

The view of FIG. 1a is a base body 12 press-molded from the base material stainless steel and having a drive 15, which base body 12 has a smaller diameter in its thread-forming region 14 than in its uncoated region 16. A material harder than the base material or a material that can be hardened by a final heat treatment is deposition-welded as a coating material 18 onto the thread-forming region 14 to be coated, as seen in FIG. 1b. According to the invention, this is carried out by deposition welding. The base body 12 coated in this way is subsequently rolled to give it its self-tapping thread 13. The thread-forming screw 10 having a hardened thread-forming region is illustrated in the view of FIG. 1c.

FIG. 2a is a partial lateral view of another embodiment exhibiting a coating variant in which weld beads 26 of coating material have been welded onto a base body 20 as seen in FIG. 1a and having a smaller diameter in its thread-forming region 16, which weld beads 26 extend parallel to the screw axis.

FIG. 2b is a cross-sectional view of the thread-forming region of the base body 20.

FIG. 3a is a sectional lateral view of a further embodiment having a base body 20. The base body 20 has axial grooves 24 in its thread-forming region 22. The coating material 26 is welded into the grooves.

FIG. 3b is a sectional view of a base body 20 as seen in FIG. 3a and coated with a coating material 26.

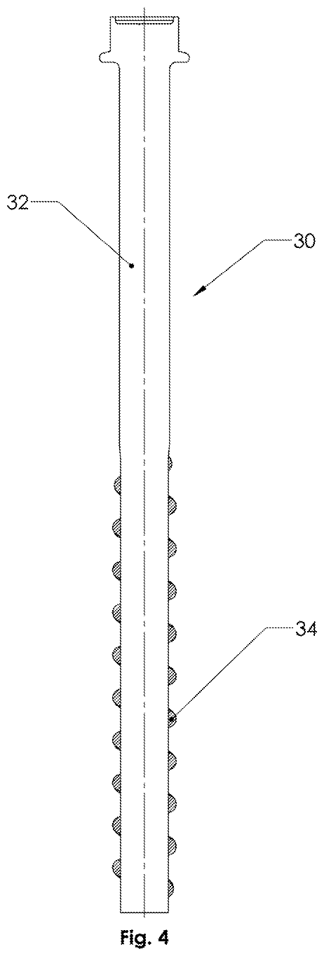

FIG. 4 is a view of a thread-forming screw 30 according to the invention, in which a helical thread bead 34 has been welded onto a screw shaft 32 made of a rustproof and acid-resistant steel. The screw 30 is designed as a concrete screw.

1. A thread-forming screw comprising a base body which comprises a drive and a screw shaft, the screw shaft carrying a thread having a thread-forming region and a load-bearing region, wherein base body is formed from a base material, and at least in the thread-forming region, the thread is formed from a coating material different from the base material that is applied to the base material by deposition welding.

2. A thread-forming screw according to claim 1, wherein the base material is a rustproof and acid-resistant steel.

3. A thread-forming screw according to claim 2, wherein the rustproof and acid-resistant steel is an austenitic stainless steel.

4. A thread-forming screw according to claim 1, wherein the base material is an aluminum alloy and the coating material is a different metal alloy or an alloy mixture.

5. A thread-forming screw according to claim 1, wherein the coat-ing material is a hardenable steel.

6. A thread-forming screw according to claim 1, wherein the coat-ing material has a layer thickness of at least 5% of the shaft diameter of the screw shaft.

7. A thread-forming screw according to claim 1, wherein the thread has an acute flank angle.

8. A thread-forming screw according to claim 1, wherein the thread has an obtuse flank angle or is rounded.

9. A thread-forming screw according to claim 7, wherein the screw is a concrete screw.

10. Method A method for producing a thread-forming screw comprising a base body which comprises a drive and a screw shaft, the screw shaft carrying a thread having a thread-forming region and a load-bearing region, which base body is formed from a base material, characterized in that at least in its thread-forming region, the thread is formed from a coating material different from the base material that is applied to the base material by deposition welding, wherein a base material of the screw shaft is at least partially coated with a coating material by deposition welding, and in that the coating material is used to form the thread in the thread-forming region.

11. A method according to claim 10, wherein the thread is produced by rolling a thread onto the screw shaft after the coating material has been deposited on the screw shaft.

12. A method according to claim 10, wherein the thread is produced by applying the coating material in helical form on the shaft in such a way that the thread is obtained immediately after the coating material has been applied.

13. A method according to claim 10, wherein the coating material is applied in the form of weld beads, dots or over the entire surface.

14. A method according to claim 13, wherein the weld beads extend parallel to the screw axis or in windings around the screw shaft.

15. A method according to claim 10, wherein the deposition welding is performed by means of laser cladding, laser powder build-up welding, arc welding or plasma-transferred arc welding.
